(19) United States
(12) Patent Application Publication
(10) Pub. No.: US 2023/0127492 A1
(43) Pub. Date: Apr. 27, 2023

(54) IMPUTATION METHOD FOR SURFACE ULTRAVIOLET IRRADIANCE BASED ON FEASIBLE CLOUD INFORMATION AND MACHINE LEARNING

(71) Applicant: Wuhan University, Wuhan (CN)

(72) Inventors: Siwei LI, Wuhan (CN); Ge SONG, Wuhan (CN); Jie YANG, Wuhan (CN); Maolin ZHANG, Wuhan (CN)

(21) Appl. No.: 17/973,533

(22) Filed: Oct. 25, 2022

(30) Foreign Application Priority Data
Oct. 26, 2021 (CN) 202111246019.0

(51) Int. Cl. G01W 1/10; G01W 1/18

(52) U.S. Cl. CPC G01W 1/10; G01W 1/18

(57) ABSTRACT

An imputation method for surface ultraviolet irradiance based on feasible cloud information and machine learning includes: establishing a deep learning model, wherein the deep learning model is designed to be a two-layered stacking ensemble learning model; constructing a first layer of the deep learning model as combination of multiple fundamental machine learning models; constructing a second layer of the deep learning model as Lasso model, which integrates an output from the first layer to obtain a final retrieval result; matching the surface ultraviolet irradiance with input features comprising cloud and meteorological information according to the temporal and spatial variables; establishing a statistical relationship between the surface ultraviolet irradiance and by training the deep learning model; and estimating the surface ultraviolet irradiance based on the trained deep learning model in regions with missing satellite observations of the surface ultraviolet irradiance.

### CROSS-REFERENCE TO RELATED APPLICATIONS

Pursuant to 35 U.S.C. § 119 and the Paris Convention Treaty, this application claims foreign priority to Chinese Patent Application No. 202111246019.0 filed Oct. 26, 2021, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a technical application for passive satellite remote sensing of surface ultraviolet irradiance and, more particularly, to an imputation method for surface ultraviolet irradiance based on cloud information and machine learning tools.

In the current stage, the anomalies of the satellite have affected the applicability of the surface ultraviolet irradiance product. The most commonly used surface ultraviolet irradiance product, which is retrieved from the observations of OMI sensor onboard Aura satellite, suffers greatly from row anomalies that some channels are not operating with designed quality. As a result, the coverage of the sensor with acceptable data quality is only around 60%. Hence, to fulfil the spatially continuous estimations of surface ultraviolet irradiance, the missing regions of satellite observations have to be imputed.

The regions with missing datasets are stripe-shaped due to the scanning mode of the sensor, and the appearances of these missing regions do not follow a fixed pattern. Thus, simple methods to impute the missing data by interpolation or geographically weighted regression cannot estimate the data of the missing regions effectively. Meanwhile, spatial and temporal variations are typical for surface ultraviolet irradiance. These factors add to the difficulty to accurately capture the characteristics of distribution of surface ultraviolet irradiance with spatial continuity. The original satellite retrieval of surface ultraviolet irradiance also suffers from low spatial resolution (1°×1°), which limits the applicability of the dataset for other subsequent research. Therefore, it remains a key difficulty to achieve estimations of surface ultraviolet irradiance with high resolution and full spatial coverage.

How to capture the characteristics of surface ultraviolet irradiance is the challenge to fulfil its full spatial coverage. Since some correlations are observed between the meteorological information and the retrieval result from the satellite passive remote sensing, statistical tools seem to show great potential, in which meteorological information and satellite-derived datasets can be used to capture the statistical relationship. However, due to the high sensitivity of the ultraviolet to cloud-information, particularly to the water and ice component as well as the cloud cover, it is necessary to employ the cloud information, which has not been effectively utilized.

On the other hand, the relationship between the surface ultraviolet irradiance and meteorological conditions are highly complex, and the physical and chemical mechanism within the relationship is not possible to be simulated with simple statistical model. Thus, an augmented model to capture the relationship is required to fit the surface ultraviolet irradiance. In recent years, machine learning tool has become a common method in the field of satellite remote sensing, which aims to resolve the data complexity issue of relative research. Since 2016, many literatures have reported methods to extract the characteristics of meteorological conditions and satellite observations, comprising Random Forest and Residual Neural Networks. However, these tools still have not completely resolved the complexity of the datasets, which produces an urgent need for high-level tools (such as deep learning) to accomplish the goals.

### SUMMARY

Imputation models based on deep learning can extract the characteristics of meteorological condition and cloud information, identify the patterns of the observed surface ultraviolet irradiance from satellite, and integrate the advantages of big data mining tools to achieve the goal of impute the missing regions of satellite ultraviolet irradiance observations. Based on this method, the imputation can be accomplished with full coverage, high precision and elevated spatial resolution.

To achieve the purpose of imputation of missing surface ultraviolet irradiance observations from satellite remote sensing, this disclosure adopts Stacking ensemble learner coupled with Lasso model to establish the imputation model based on cloud information and meteorological information.

Stacking technique, as an ensemble learner, can integrate the advantages of multiple regressors to enhance the machine learning model performance. The Stacking ensemble learner have two layers. The first layer ensembles four machine learning models, comprising Random Forest, XGBoost, LightGBM, Catboost and LightGBM. The ensemble learner condenses the advantageous features from the machine learning models and provides highly compact estimations. These estimations, as the input features of the second layer, provide support for the highly accurate prediction in the second layer. Among the machine learning models, the Random Forest model can generate an internal unbiased estimate of the generalization error; the XGBoost model can effectively prevent overfitting, thereby improving the generalization ability of the model; LightGBM has fast processing speed, uses less memory, and has high potential for industrial applications; Catboost model reduces the need for hyperparameter tuning, and the model is highly versatile. The second layer of the Stacking ensemble learner uses a simple Lasso model to synthesize the results in the first layer to obtain the final estimations. The Lasso model has the advantage of simple model structure and avoids the potential overfitting. By combinations of these models, the Stacking ensemble learner therefore performs well in terms of model accuracy, generalization, application efficiency, and robustness. The diagram of the final deep learning model is shown in the description part. The deep learning model in this disclosure adopts the above-mentioned complex structure, which can provide support for accurately capturing the data characteristics of surface ultraviolet irradiance, cloud information and meteorological information. The deep learning model is the key to accomplishing the imputation with high accuracy.

Due to the finer resolution of cloud information and the meteorological information obtained from the European Centre for Medium-Range Weather Forecasts (ECMWF), the imputation enables the enhancement of the resolution of the ultraviolet irradiance as well. The high temporal and spatial resolution of meteorological and cloud information ensures the spatial continuity of the imputation, which is the key to the achievement of surface ultraviolet imputation with high resolution and full coverage.

In summary, the use of complex deep learning networks and the incorporation of cloud information is the essential support to provide the surface ultraviolet irradiance imputation with high resolution and full coverage.

To achieve the goal of surface ultraviolet irradiance imputation with high resolution and full coverage, this disclosure conducts feature selection, comprising the following aspects: (1) the cloud information, comprising the cloud coverage, cloud ice water component and cloud liquid water component are involved as input feature of the model; (2) the meteorological condition would directly determine the surface ultraviolet, thus presented as the model input; (3) spatial information, comprising latitude and longitude, has close relationship with the solar radiation and thereby included in the model; (4) since the surface ultraviolet irradiance has strong temporal reliance, the temporal information such as year, month and day are used as well.

To achieve the above goals, three steps are processed in this disclosure: A) setup of deep learning model; B) establishment of statistical relationship between surface ultraviolet irradiance and its relevant factors; C) application of the trained model to impute the missing observations. The setup of deep learning model refers to the construction of Stacking ensemble learner. The establishment of statistical relationship for surface ultraviolet irradiance involves the spatial and temporal matching of the satellite observations with corresponding cloud and meteorological information, followed by the training of the deep learning model. The application of the model is to provide fast estimations on surface ultraviolet irradiance in regions where satellite observations are missing based on the trained deep learning model in the previous step.

Setup of Deep Learning Model

The environment of the deep learning model in this disclosure is the Python 3.8. The modules that are employed in this deep learning framework comprise mlxtend, catboost, xgboost, lightgbm and sklearn.

Due to the great enhancement of the model generalization by the ensemble learner, the Stacking technique chosen to work as the foundation of the imputation model. In this disclosure, the Stacking ensemble learner has the ability to integrate the advantages of multiple machine learning models to optimize the performance of imputation.

The first layer of the Stacking structure uses 4 simple machine learning models, comprising Random Forest, XGBoost, LightGBM and CatBoost. The second layer of the Stacking framework sets Lasso as the regressor to combine the outcomes from the first layer.

Except from Random Forest with a fixed setup of number of decision trees as 100, parameters of other machine learning models are determined by the grid search method.

Training of Deep Learning Models for Existing Satellite Observations

To prepare the necessary datasets for the deep learning model, the satellite-based surface ultraviolet products with long temporal and spatial range are collected. The retrieved surface ultraviolet irradiance is denoted as UV, accompanied with its temporal information (denoted as YY/MM/DD) and spatial information (latitude denoted as LAT, longitude demoted as LON). For example, surface ultraviolet irradiance from product OMUVBd by OMI sensor onboard Aura satellite consists of ultraviolet irradiance at multiple wavelengths (305 nm, 310 nm, 324 nm and 380 nm).

The meteorological datasets and cloud information with the same temporal coverage is then collected. These variables comprise, cloud coverage (TCC), total cloud ice water content (TCIW), total cloud liquid water content (TCLW), surface temperature (ST), dewpoint temperature (DT), surface pressure (SP), U-direction wind speed (UW), V-direction wind speed (VW), boundary layer height (BLH). Relative humidity (RH), total precipitation (TP) and total evaporation (TE). For example, ERAS products from ECMWF provides information of international climate analysis service with products resolution of 0.25°×0.25° and a global coverage.

A data table can be constructed by matching the satellite ultraviolet irradiance, meteorological information, cloud information and auxiliary information by the spatial and temporal variables.

The deep learning model (DL) is trained with input feature of variables comprising YY, MM, DD, LAT, LON, TCC, TCIC, TCLC, ST, DT, SP, UW, VW, BLH, RH, TP and TE. The model is then trained by the above Stacking ensemble learner with the model target of UV.

Application of the Model to Impute the Missing Satellite Observations

The target of the imputation model is to fill the missing data of satellite-observed surface ultraviolet irradiance. However, other datasets comprising the meteorological condition, the cloud information are available with global coverage. Therefore, the information is arranged for all records with a spatial resolution of 0.25°×0.25° from regions is obtained where satellite observations are available.

The above features are input into the already trained deep learning model to obtain the estimated surface ultraviolet irradiance in regions where the original observations are missing. The output of the surface ultraviolet irradiance is downscaled to 0.25°×0.25° during this process.

In this disclosure, the method to impute the missing surface ultraviolet irradiance breaks through the limits of coverage and spatial resolution of the satellite-based observations. It fully makes use of the statistical relationship between the surface ultraviolet irradiance and relative variables, comprising cloud information and the meteorological information. The imputation model has achieved full coverage, high precision and fine resolution of surface ultraviolet irradiance. Furthermore, the foundation of the imputation is built on the deep learning model, which has the advantage of fast computation. The precise imputation result can be further applied to applications in other relevant fields.

### BRIEF DESCRIPTION OF THE DRAWINGS

Some more features, purposes, and advantages of the disclosure will become more apparent by reading a detailed description of the following figures as non-restrictive embodiments of the disclosure.

FIG. 1 is the flowchart of procedures in this disclosure;

FIG. 2 is the framework of the Stacking ensemble learner in this disclosure;

FIG. 3 is a scatterplot of the model-derived surface ultraviolet irradiance versus the original satellite-observed surface ultraviolet irradiance, validated by cross-validation; and

FIG. 4 is the effect of cloud information on the model performance under different validation schemes.

FIG. 5 is geolocation of Hong Kong, a coastal city.

FIG. 6 is temporal variation of imputed UV index, versus the originally satellite-observed UV index, where the missing data is caused by row anomaly of satellite or high cloud coverage.

### DETAILED DESCRIPTION

The embodiments of the disclosure are described in detail as following. The embodiments of the disclosure are implemented on the premise of the technical scheme of the disclosure, and the detailed embodiments and the specific operation process are given. It should be pointed out that a person skilled in the art can make several deformations and improvements without breaking away from the idea of the present disclosure, which belong to the protection scope of the present disclosure.

1. Implementation Goals

This embodiment takes an example of the application of UV index, a sub-product of the satellite UV product. This embodiment makes use of satellite-observed UV index as means of monitoring of risks of skin cancer. To be specific. UV index higher than 10 indicates dangerous exposure to UV and high risk of skin cancer and UV index lower than 2 suggests no practices will be necessary. However, the impairment of the satellite sensors named “row anomaly” causes deterioration of data coverage. Meanwhile, the cloud hinders algorithms of UV index to be highly accurate. Given the above circumstance, the imputation of surface ultraviolet irradiance method proposed in this disclosure would be the best solution to provide data on missing regions, thus providing an overall evaluation of risks of skin cancer in Hong Kong in the year of 2018.

2. Data Selection

The surface ultraviolet irradiance product OMUVBd from OMI sensor onboard Aura satellite provides information of ultraviolet at a series of wavelengths, such as 305 nm, 310 nm, 324 nm and 380 nm, as well as UV index. It has a spatial resolution of 1°×1° and a temporal resolution of daily-level. In this embodiment, the ultraviolet irradiance at 380 nm is selected. To achieve the high-resolution and full-coverage surface ultraviolet irradiance estimations in the range of mainland China, the OMUVBd products in the year of 2018 are selected as a foundation. Meanwhile, data products of ERAS from ECMWF with the same spatial and temporal range are collected along with the satellite products. The cloud information is obtained from ECMWF as well. The above datasets are the raw materials for the statistical model to correlate the available surface ultraviolet irradiances with the variables. To depict the UV index in Hong Kong, the geolocation of the city is used as following: 114.17° E 22.32° N.

3. Implementation Process

A) Setup of deep learning model (DL)

1) Loading the Python 3.8 and installing the modules comprising mlxtend, catboost, xgboost, lightgbm and sklearn.

2) Constructing a framework of Stacking ensemble learner; applying four modules in the first layer of the Stacking ensemble learner, comprising Random Forest, XGBoost, LightGBM and CatBoost; and applying Lasso as a generalized linear regression model in the second layer of the Stacking ensemble learner

3) Setting the of number of decision trees as 100 in the Random Forest model; and determining the parameters of other machine learning models by the grid search method.

B) Training of deep learning models for existing satellite observations

1) collecting the satellite products OMUVBd, reanalysis products ERAS and USGS-SRTM in the year of 2018 with spatial coverage of mainland China.

2) constructing a data table to organize the available satellite products by matching the satellite ultraviolet irradiance, meteorological information, cloud information and auxiliary information according to the date, latitude and longitude; and forming the final data table with spatial resolution of 0.25° and temporal resolution of daily level.

3) training the deep learning model (DL) with input feature of variables comprising YY, MM, DD, LAT, LON, TCC, TCIC, TCLC, ST, DT, SP, UW, VW, BLH, RH, TP, TE for the records in the data table where the satellite-observed surface ultraviolet irradiance is available; saving the deep learning model.

C) Application of the model to impute the missing satellite observations

1) preparing the input of the application model of YY*, MM*, DD*, LAT*, LON*, TCC*, TCIC*, TCLC*, ST*, DT*, SP*, UW*, VW*, BLH*, RH* and TP* from the data table, whose coverage should be global and have a daily-level temporal resolution.

2) running the trained model DL by delivering the input dataset to obtain the spatially continuous surface ultraviolet irradiances UV*.

4. Method Evaluation

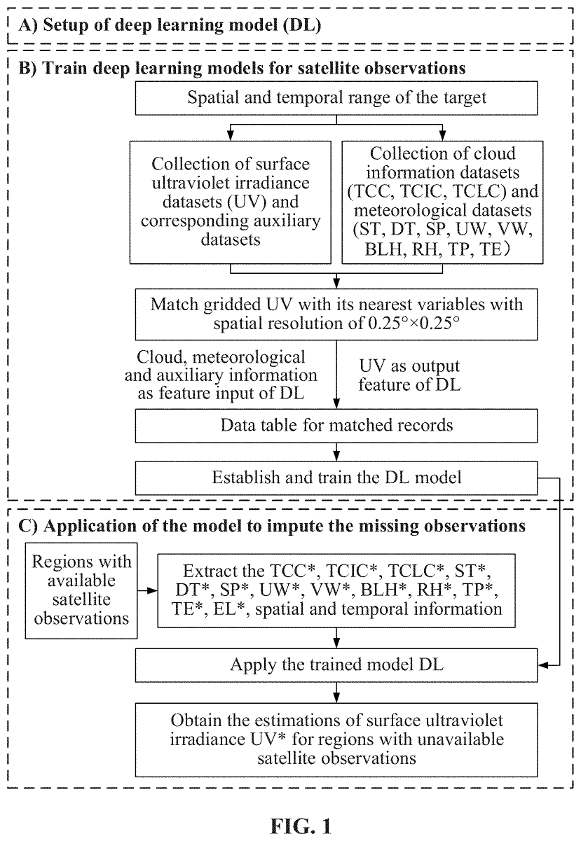

The cross-validation is conducted to evaluate the practicability, precision and robustness of this disclosure. In the validation, the collected records containing satellite surface ultraviolet irradiance observations are randomly divided into 90% training set and 10% testing set. The DL model is trained on the training set and tested on the testing set. Then the validation runs repeatedly for 10 ten times until all records are used as the testing set for once. FIG. 1 demonstrates the precision of the imputation model. The model performance on the testing sets indicate that the model can achieve a high accuracy of 0.98. The RMSE of the trained model is 28.39 mW/nm/m². The results prove that the method proposed in this disclosure can be highly accurate and robust. Furthermore, the spatial coverage of the imputed surface ultraviolet irradiance reaches 100%. These results ensures that the disclosure has outstanding applicability.

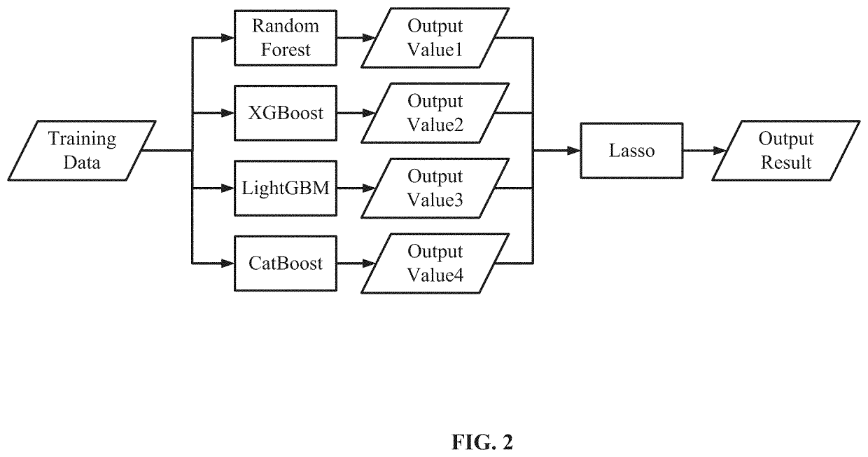

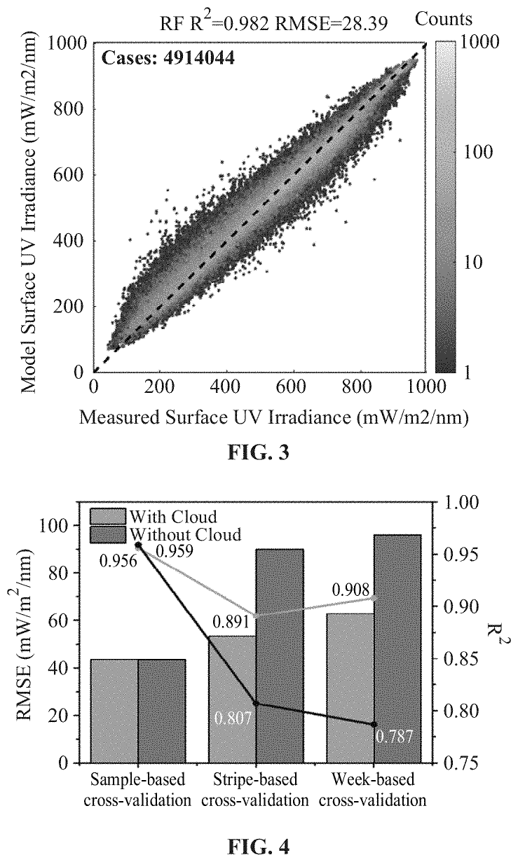

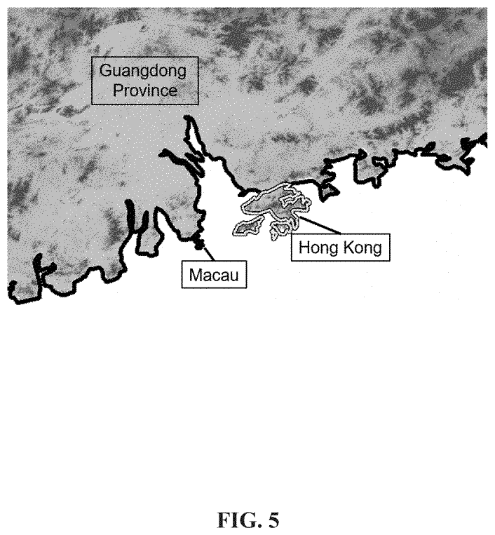

By validation under different schemes, the importance of the cloud information is highlighted in this disclosure. The schemes of validations are the sample-based cross-validation, which is described as above; the stripe-based cross-validation, where data records are divided to a proportion of 50% training set and 50% testing set according to the longitude. In detail, the data records belonging to the longitude of 75°-85°, 95°-105°, 115°-125° are arranged to training set and the rest records are assigned to testing set. The last validation scheme is the week-based validation, where data records in the odd number of weeks are assigned to the training set and the rest are assigned to testing set. FIG. 2 depicts the difference of model performance between situations with and without cloud information under the above validation schemes. The results present significant differences in the space-based (stripe-based) cross-validation and time-based (week-based) validation. In the space-based validation, the model with cloud information has high accuracy of 0.891, which is significantly enhanced compared to model without cloud information (R²=0.807). In the time-based validation, cloud information improved the model accuracy from 0.787 to 0.908. The great difference suggests that the cloud information strongly relieves the over-fitting issue of the model. Therefore, if the disclosure is not adopted and only meteorological information is employed as the input features, the errors of imputation would be large.

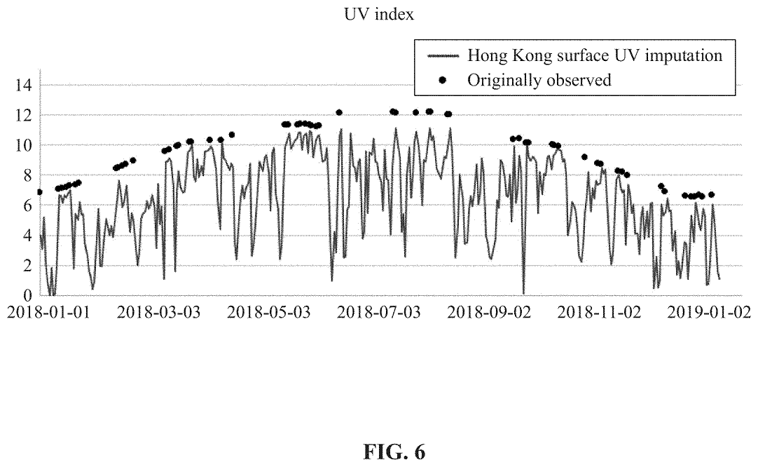

The embodiment targets to monitor and evaluate the risk of skin cancer via the indicator of human's exposure to surface UV irradiance, namely, UV index. The embodiment depicts the utilization of this disclosure in Hong Kong in the year of 2018. FIG. 5 presents the geolocation of Hong Kong, a subtropical coastal city which is inclined to cloudy days. FIG. 6 reflects the effectiveness of this disclosure, as data unavailability appears in most days in Hong Kong in the year of 2018, especially during the frequent cloudy days. By imputation of the satellite UV products, a complete record of UV index can be obtained.

The specific embodiments described herein are merely illustrative of the spirit of the disclosure. Those skilled in this field to which this disclosure pertains can make various modifications or additions to the described specific embodiments or substitute in similar manners but will not deviate from the spirit of the present disclosure or go beyond the definition of the appended claims.

What is claimed is:

1. An imputation method for surface ultraviolet irradiance based on feasible cloud information and machine learning, the method comprising:
A) establishing a deep learning model, wherein the deep learning model is designed to be a two-layered stacking ensemble learning model; constructing a first layer of the deep learning model as combination of multiple fundamental machine learning models; constructing a second layer of the deep learning model as Lasso model, which integrates an output from the first layer to obtain a final retrieval result;
B) matching the surface ultraviolet irradiance with input features comprising cloud and meteorological information according to date, latitude and longitude; establishing a statistical relationship between the surface ultraviolet irradiance and the input features by training the deep learning model; and
C) estimating the surface ultraviolet irradiance based on the trained deep learning model in regions with missing satellite observations of the surface ultraviolet irradiance; and
D) inputting the cloud and meteorological information to produce an UV index.

2. The method of 1, wherein the multiple fundamental machine learning models in A) comprise at least a Random Forest model.

3. The method of 1, wherein the multiple fundamental machine learning models comprise Random Forest, XGBoost, LightGBM, and CatBoost.

4. The method of 1, wherein step B) comprises:
B1) collecting the surface ultraviolet irradiance from the satellite products OMUVBd with temporal range of 1 year and spatial range covering more than 700 km×700 km comprising the surface ultraviolet irradiance at specific wavelengths together with latitude and longitude where: the surface ultraviolet irradiance is denoted as UV; the date is denoted as YY/MM/DD, with YY as the year, MM as the month and DD as the day; latitude is denoted as LAT; longitude is denoted as LON;
B2) collecting the input variables comprising meteorological information and cloud information from ERAS products, wherein: cloud information variables comprise cloud coverage (TCC), total cloud ice water content (TCIW), total cloud and liquid water content (TCLW); the meteorological information variables comprise: surface temperature (ST), dewpoint temperature (DT), surface pressure (SP), U-direction wind speed (UW), V-direction wind speed (VW), boundary layer height (BLH), relative humidity (RH), total precipitation (TP) and total evaporation (TE);
B3) constructing a data table by matching the satellite ultraviolet irradiance, meteorological information, cloud information and auxiliary information by the date, latitude and longitude; and
B4) setting up the deep learning model (DL) in regions where satellite surface ultraviolet irradiance is available with input feature of variables comprising date, latitude and longitude, satellite ultraviolet irradiance, meteorological information and cloud information; training the deep learning model with a model target of UV.

5. The method of 1, wherein step C) comprises:
C1) reading the meteorological information, the cloud information and the date with global coverage from ERAS products; and
C2) acquiring the full-coverage global surface ultraviolet irradiance by inputting the cloud information, meteorological information, temporal information and geological information into the deep learning model.

6. The method of 1, wherein step D) comprises:
D1) applying the geolocation information of Hong Kong and finding the corresponding TCC, TCIW, TCLW, ST, DT, SPT, DT, SP, UW, VW, BLH, RH, TP, TE, YY/MM/DD, LAT and LON of the specific geolocation; and
D2) obtaining the UV index by inputting the variables as listed in D1 into the trained deep learning model (DL).
